(19) United States
(12) Patent Application Publication
(10) Pub. No.: US 2025/0348637 A1
(43) Pub. Date: Nov. 13, 2025

(54) METHOD FOR OPTIMIZING MESHING AND ESTABLISHING HYDRODYNAMIC MODEL OF SHALLOW LAKE MODEL

(71) Applicant: HEBEI INSTITUTE OF WATER SCIENCE, Shijiazhuang City (CN)

(72) Inventors: Yongtao ZHU, Shijiazhuang City (CN); Xueping HUO, Shijiazhuang City (CN); Meng YANG, Shijiazhuang City (CN); Zhijiu HUO, Shijiazhuang City (CN); Yuanyuan MA, Shijiazhuang City (CN); Zhihua ZHANG, Shijiazhuang City (CN); Yuan LI, Shijiazhuang City (CN); Haonan ZHAO, Shijiazhuang City (CN)

(21) Appl. No.: 18/989,195

(22) Filed: Dec. 20, 2024

(30) Foreign Application Priority Data
May 10, 2024 (CN) 202410573564.8

(51) Int. Cl. G06F 30/28; G06F 113/08

(52) U.S. Cl. CPC G06F 30/28; G06F 2113/08

(57) ABSTRACT

Provided are a method for optimizing meshing and establishing a hydrodynamic model of a shallow lake model, relating to the technical field of numerical simulation for rivers and lakes. The method for optimizing meshing of a shallow lake model includes the following steps: S110: obtaining a topographic map; S120: taking a midline of an original boundary line of each dike or embankment in the topographic map; S140: offsetting the midline by a preset distance to form a new topographic map with equidistant double boundary lines; and S160: importing the new topographic map into meshing software for re-meshing to obtain a mesh file of a simulation area. The method for establishing a hydrodynamic model includes the above method for optimizing meshing of a shallow lake model.

### CROSS REFERENCE TO RELATED APPLICATION

This patent application claims the benefit and priority of Chinese Patent Application No. 2024105735648, filed with the China National Intellectual Property Administration on May 10, 2024, the disclosure of which is incorporated by reference herein in its entirety as part of the present application.

### TECHNICAL FIELD

The present disclosure relates to the technical field of numerical simulation for rivers and lakes, and in particular, to a method for optimizing meshing and establishing a hydrodynamic model of a shallow lake model.

### BACKGROUND

In the establishment of hydrodynamic models, the hydrodynamic module in MIKE 21 can simulate hydrodynamic changes of water bodies under the influence of multiple parameters and can couple with other modules such as water quality and sediment transport for joint calculations. The MIKE 21FM HD module uses unstructured meshes for calculations, employing the finite volume method at the cell center. Meshing is performed using the mesh generator provided by MIKE ZERO. Common mesh types in two-dimensional models include structured meshes and unstructured meshes, with unstructured meshes being more suitable for meshing in complex terrain areas compared to structured meshes.

Baiyangdian is a shallow lake with a complex terrain. The Baiyangdian area has numerous dikes and embankments of varying heights, leading to significant fragmentation of the terrain. Therefore, unstructured meshes are more appropriate. When using existing model establishment methods, it is necessary to import a topographic map into the mesh generator provided by MIKE ZERO for meshing. The mesh generator generates an unstructured mesh composed of triangular cells based on elevations of boundary lines in the topographic map, where the vertices of the triangles represent elevations, and boundaries of dikes and embankments are composed of specific nodes of the triangular cells. A file of the unstructured mesh is then imported into MIKE 21 software to establish a hydrodynamic model. However, since the original boundary lines of the dikes and embankments in the topographic map are measured and have uneven widths, the data calculation volume in the established hydrodynamic model after meshing is relatively large.

Therefore, the inventor proposes taking the midlines of the original boundary lines of the dikes and embankments to form a new topographic map, which is then imported into the mesh generator for meshing. This way, the dikes and embankments can be represented by single lines in the mesh file (note: the gray line in FIG. 1 represents a dike or embankment, composed of several vertices of continuous triangular cells), which can significantly reduce the calculation volume. However, the effect displayed on an elevation map after meshing in this manner is sometimes not ideal, as shown in FIG. 2. In the terrain presented in this way, although the dike and embankment parts appear as raised areas that can partially block water, it does not completely reflect the actual situation and cannot fully achieve the water-blocking effect.

Through research, the inventor found that although the dike or embankment, after taking the midline of the original boundary, is displayed as a single line in the unstructured mesh file after meshing, this line merely fits the boundary line of the dike or embankment in the topographic map, while the effective nodes are only those on the boundary line. Data for the mesh calculations are derived from comprehensive assignment of data from three vertices, which does not match the actual situation and is underestimated, leading to poor water-blocking effects.

Therefore, it is necessary to optimize the existing meshing methods for hydrodynamic models.

### SUMMARY

An objective of the present disclosure is to provide a method for optimizing meshing and establishing a hydrodynamic model of a shallow lake model to solve the technical problem of large data calculation volumes in hydrodynamic models established by meshing based on original boundary lines of dikes and embankments in the prior art.

To achieve the above objective, the technical solution adopted by the present disclosure is to provide a method for optimizing meshing of a shallow lake model, including the following steps:
S110: obtaining a topographic map;
S120: taking a midline of an original boundary line of each dike or embankment in the topographic map;
S140: offsetting the midline by a preset distance to form a new topographic map with equidistant double boundary lines;
S160: importing the new topographic map into meshing software for re-meshing to obtain a mesh file of a simulation area.

In conjunction with the above technical solution, in one possible implementation, in S140, the original boundary line of the dike or embankment in the topographic map is offset to one side by a first preset distance to form an offset line, and an elevation of the offset line is consistent with an elevation of the boundary line of the dike or embankment; the dike or embankment is represented by equidistant double boundary lines formed by the boundary line and the offset line, where the first preset distance is an average width of the original boundary line of the dike or embankment.

In conjunction with the above technical solution, in one possible implementation, in S140, the original boundary line of the dike or embankment in the topographic map is offset to both sides by a second preset distance to form two offset lines, and an elevation of the two offset lines is consistent with an elevation of the original boundary line, and the original boundary line is deleted; the dike or embankment is represented by equidistant double boundary lines formed by the two offset lines, where the second preset distance is half of an average width of the original boundary line of the dike or embankment.

In conjunction with the above technical solution, in one possible implementation, in S160, the new topographic map obtained is imported into a mesh generator provided by MIKE ZERO for re-meshing to obtain the mesh file of the simulation area, where an area within the equidistant double boundary lines undergoes mesh refinement to form single-layer triangle mesh with a density greater than a density of an area outside the double boundary lines.

In conjunction with the above technical solution, in one possible implementation, between S120 and S140, the method further includes:
S130: straightening the midline: dividing a curved portion of the midline into a plurality of segments and replacing parts within each segment with a straight line connecting endpoints of the segment, thereby forming a new center.

In conjunction with the above technical solution, in one possible implementation, between S140 and S160, the method further includes:
S150: setting variable mesh boundary lines: offsetting the equidistant double boundary lines to both sides by a third preset distance d to form preliminary mesh boundary lines; when the preliminary variable mesh boundary lines of a dike or embankment do not intersect with the preliminary mesh boundary lines of a neighboring dike or embankment, that is, when a distance between the two adjacent dikes or embankments is greater than 2d, defining the preliminary mesh boundary lines as the variable mesh boundary lines; when the preliminary variable mesh boundary lines of a dike or embankment intersect with the preliminary mesh boundary lines of a neighboring dike or embankment, if a distance between the two adjacent dikes or embankments ranges from d to 2d, taking a midline of an intersecting part of the preliminary mesh boundary lines, and combining the midline of the intersecting part with non-intersecting parts to define the variable mesh boundary lines; if the distance between the two adjacent dikes or embankments is less than d, deleting the intersecting part of the preliminary mesh boundary lines, and combining the non-intersecting parts to define the variable mesh boundary lines.

In S160, a part between the equidistant double boundary lines and the variable mesh boundary lines gradually increases in cell size from the equidistant double boundary lines to the variable mesh boundary lines.

To achieve the above objective, another technical solution adopted by the present disclosure is to provide a method for establishing a hydrodynamic model, including the following steps:
S100: obtaining a mesh file of a simulation area by using the above method for optimizing meshing of a shallow lake model;
S200: establishing a blank MIKE21 hydrodynamic model in MIKE21 software and importing the mesh file of the simulation area into the MIKE21 software;
S300: selecting measurement monitoring points, determining corresponding positions of the measurement monitoring points in the MIKE21 hydrodynamic model as calculation nodes, and collecting and outputting monitoring data from the calculation nodes;
S400: calibrating parameters of control equations for hydrodynamic indicators based on the monitoring data and prediction data of each calculation node, to simulate and predict the hydrodynamic indicators;
S500: dynamically updating a forecast part of the hydrodynamic model based on the collected monitoring data from each calculation node and simulated values of the hydrodynamic model, to obtain prediction data.

In conjunction with the above technical solution, in one possible implementation, after importing the mesh file of the simulation area into the MIKE21 software, and before collecting and outputting the monitoring data from the calculation nodes, it is also necessary to integrate multidimensional information of a river channel in a static water state, and map the multidimensional information to initial values of each cell in the MIKE21 hydrodynamic model, where the multidimensional information includes water quality monitoring information, underwater topography information, geographic information, meteorological information, and satellite remote sensing information; the monitoring data from the calculation nodes includes water level data and water flow data; the measurement monitoring points are equipped with water flow monitoring devices and water level monitoring devices.

In conjunction with the above technical solution, in one possible implementation, in S400, the control equations of the hydrodynamic model are as follows:

### Continuity Equation:

$$\frac{\partial h}{\partial t} + \frac{\partial ( hu )}{\partial x} + \frac{\partial ( hv )}{\partial y} = 0 ;$$

### X-Direction Momentum Equation:

$$\frac{\partial p}{\partial t} + \frac{\partial }{\partial x} ( \frac{{p}^{2}}{h} ) + \frac{\partial }{\partial y} ( \frac{pq}{h} ) + gh \frac{\partial ζ}{\partial x} + \frac{gp \sqrt{{p}^{2} + {q}^{2}}}{{c}^{2} {h}^{2}} - \frac{1}{{p}_{ω}} [ \frac{\partial }{\partial x} ( {hτ}_{xx} ) + \frac{\partial }{\partial y} ( {hτ}_{xy} ) ] - Ω q - {fVV}_{x} + \frac{h}{{p}_{ω}} \frac{\partial }{\partial x} ( {p}_{a} ) = {S}_{ix} ;$$

### Y-Direction Momentum Equation:

$$\frac{\partial p}{\partial t} + \frac{\partial }{\partial y} ( \frac{{p}^{2}}{h} ) + \frac{\partial }{\partial x} ( \frac{pq}{h} ) + gh \frac{\partial ζ}{\partial y} + \frac{gp \sqrt{{p}^{2} + {q}^{2}}}{{c}^{2} {h}^{2}} - \frac{1}{{p}_{ω}} [ \frac{\partial }{\partial y} ( {hτ}_{yy} ) + \frac{\partial }{\partial x} ( {hτ}_{xy} ) ] - Ω q - {fVV}_{y} + \frac{h}{{p}_{ω}} \frac{\partial }{\partial y} ( {p}_{a} ) = {S}_{iy} ;$$

where h(x, y, t) represents a bottom elevation (=ζ−d, m); d(x, y, t) represents a water depth (m); ζ(x, y, t) represents a water surface elevation (m); p, q(x, y, t) represents a flow density in direction x or y (m³/s/m), which is equal to ph, vh; μ and v represent flow velocities in directions x and y distributed along the water depth (m/s); C(x, y) represents a Chezy coefficient (m^{1/2}/s); g represents a gravitational acceleration (m/s²); f(V) represents a wind friction coefficient; V, Vx, Vy(x, y, t) represent wind speed flows in directions x and y (m/s); Ω(x, y) represents a Coriolis force parameter, latitude-related (s⁻¹); pa(x, y, t) represents an atmospheric pressure (kg/m/s²); pw represents a water density (kg/m); x and y represent x-direction and y-direction coordinates; t represents time; τxx, τxy, and τyy represent effective shear stress components; and

an implicit alternating direction technique is used to discretize mass and momentum equations of the hydrodynamic model, and resulting matrix equations are solved using the Thomas algorithm; all differential terms and important coefficients are treated using a central difference format, where a truncation error of a Taylor series expansion is required to achieve second to third-order accuracy.

In conjunction with the above technical solution, in one possible implementation, an unstructured mesh is used to mesh the simulation area, employing topographic data for meshing of the simulation area; a terrain is divided into high land areas, village areas, dikes and embankments, areas inside the dikes and embankments, water surface areas, and reed areas based on topographic boundaries; partial mesh refinement is performed for embankment parts, and generalization processing is performed on water surface parts; during meshing of the simulation area using the topographic data, a separate cell size is set for each terrain area, where the water surface area has a largest cell size, and the reed area has a smallest cell size; after completing the meshing of the simulation area, the method further includes deleting and merging small cells to form an unstructured triangle mesh for the simulation area.

In conjunction with the above technical solution, in one possible implementation, the method for establishing a hydrodynamic model further includes:
S600: field verification: selecting a plurality of measurement points in the hydrodynamic model, obtaining flow state data, measuring flow states at field locations corresponding to the measurement points, and then comparing field measurement data with the flow state data obtained from the hydrodynamic model to verify prediction accuracy of the hydrodynamic model.

In conjunction with the above technical solution, in one possible implementation, in S600, a flow state measurement apparatus is used for measuring the flow states at the field locations. The flow state measurement apparatus includes a fixed pin, a rotating connection seat, a water flow pipe, a flow velocity sensor, a depth scale, an elevation angle scale, a curved bubble tube, and a counterweight component. The fixed pin is used to be inserted into sediment at the bottom of water. The rotating connection seat is mounted on the fixed pin and has degrees of freedom to rotate along vertical and horizontal axes. The water flow pipe is rotatably connected to the rotating connection seat along the horizontal axis. The flow velocity sensor is located inside the water flow pipe. The depth scale has one end connected to the fixed pin or the rotating connection seat, and the other end extending upward. The curved bubble tube is a transparent tubular structure in an arc shape, mounted on the water flow pipe, where a center of the curved bubble tube is located on the horizontal axis, and a measuring liquid having bubbles is provided inside the curved bubble tube. The elevation angle scale is marked with scale lines and is positioned at a side of the curved bubble tube facing the water flow pipe, allowing the scale lines to be visible from above. The counterweight component is located on the water flow pipe to adjust the balance of the water flow pipe.

The method for optimizing meshing of a shallow lake model provided by the present disclosure has the following beneficial effects: Compared with the prior art, the present disclosure takes the midline of the original boundary line of each dike or embankment, and then offsets the midline by a preset distance to form a new topographic map with equidistant double boundary lines. The new topographic map is imported into meshing software for re-meshing, resulting in a mesh file for the simulation area. This allows for the formation of a layer of uniform triangular cells within the equidistant double boundary lines in the resulting file, where all vertices of the triangular cells are at the same elevation and have a similar shape. This can create a band-like protrusion that fully represents the elevation of the dike or embankment, which is more consistent with the actual situation of the dike or embankment and can achieve the water-blocking effect of the dike or embankment while significantly reducing the computational load of the hydrodynamic model. Additionally, since the water flow movement at the dikes and embankments is very minimal, the optimization through the above method has a small impact on the accuracy of the ultimately established hydrodynamic model.

The method for establishing a hydrodynamic model provided by the present disclosure has the following beneficial effects: Compared with the prior art, the present disclosure uses the method for optimizing meshing of a shallow lake model to mesh the topographic map, allowing the established hydrodynamic model to better reflect the actual situation of the dikes and embankments, achieving the water-blocking effect while significantly reducing the computational load of the hydrodynamic model.

### BRIEF DESCRIPTION OF THE DRAWINGS

To describe the technical solutions in the embodiments of the present disclosure more clearly, the following briefly describes the accompanying drawings required for describing the embodiments or the prior art. Apparently, the accompanying drawings in the following description merely show some embodiments of the present disclosure, and persons of ordinary skill in the art may still derive other accompanying drawings from these accompanying drawings without creative efforts.

FIG. 1 is a schematic diagram of a mesh file generated after meshing using an existing method;

FIG. 2 is an elevation map generated using the mesh file obtained from the existing method;

FIG. 3 is a flowchart of a method for optimizing meshing of a shallow lake model according to an embodiment of the present disclosure;

FIG. 4 is a schematic structural diagram of a flow state measurement apparatus according to an embodiment of the present disclosure;

FIG. 5 is a cross-sectional schematic structural diagram of a counterweight component of the flow state measurement apparatus according to an embodiment of the present disclosure;

FIG. 6 is a schematic diagram illustrating a state after variable mesh boundary lines are generated using the method for optimizing meshing of a shallow lake model according to an embodiment of the present disclosure;

FIG. 7 is a schematic diagram of a mesh file generated using the method for optimizing meshing of a shallow lake model according to the embodiment shown in FIG. 6 of the present disclosure;

FIG. 8 is a schematic diagram of a mesh file generated using the method for optimizing meshing of a shallow lake model according to an embodiment of the present disclosure;

FIG. 9 is an elevation map generated from the mesh file generated using the method for optimizing meshing of a shallow lake model according to an embodiment of the present disclosure; and

FIG. 10 is a water level spatial distribution map of simulation results generated by a method for establishing a hydrodynamic model according to an embodiment of the present disclosure.

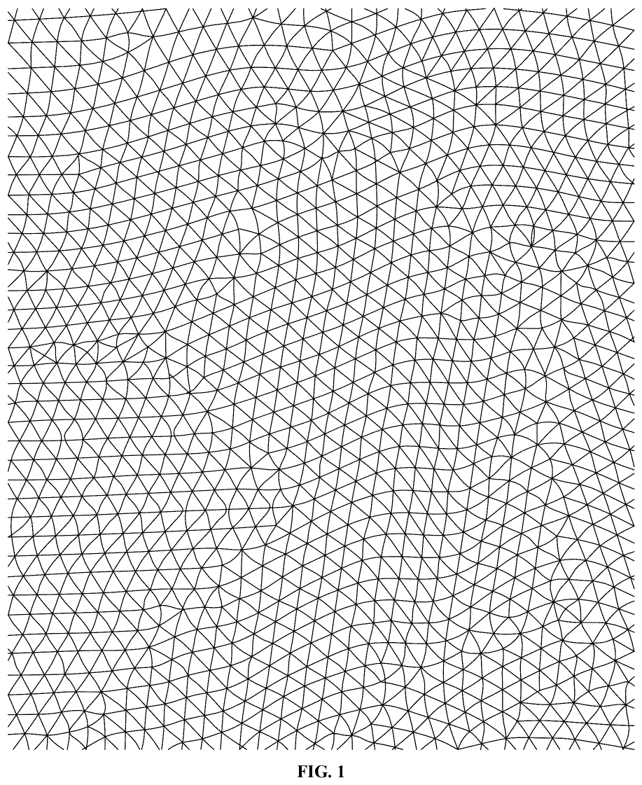

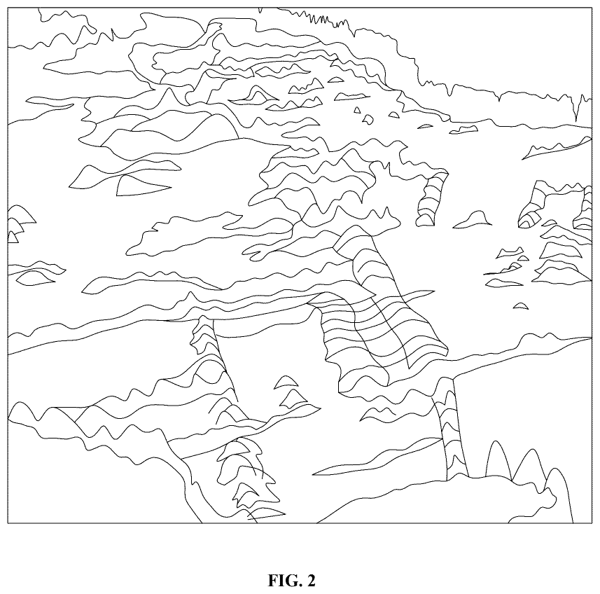

### REFERENCE NUMERALS

10: fixed pin; 20: rotating connection seat; 30: water flow pipe; 40: flow velocity sensor; 50: depth scale; 60: elevation angle scale; 70: curved bubble tube; 71: bubbles; 80: counterweight component; 81: sac body; 82: outer sealing plate; 83: spring clamp; 84: inner cavity adjustment bolt;
100: equidistant double boundary lines; 200: variable mesh boundary lines.

### DETAILED DESCRIPTION OF THE EMBODIMENTS

To make the to-be-resolved technical problems, the technical solutions, and the beneficial effects of the present disclosure clearer, the present disclosure is described in further detail below with reference to the accompanying drawings and embodiments. It should be understood that the described embodiments are only some rather than all embodiments of the present disclosure. The specific embodiments described herein are only used to explain the present disclosure, but not to limit the present disclosure. All other embodiments obtained by those of ordinary skill in the art based on the embodiments of the present disclosure without creative efforts should fall within the protection scope of the present disclosure.

It should be further noted that the accompanying drawings and embodiments of the present disclosure mainly describe the concepts of the present disclosure. Based on this concept, specific forms and arrangements of some connection relationships, positional relationships, power mechanisms, power supply systems, hydraulic systems, and control systems may not be fully described. However, under the premise that those skilled in the art understand the concept of the present disclosure, those skilled in the art can implement the above specific forms and arrangements using familiar methods.

Now, a method for optimizing meshing and establishing a hydrodynamic model of a shallow lake model provided by the present disclosure will be described.

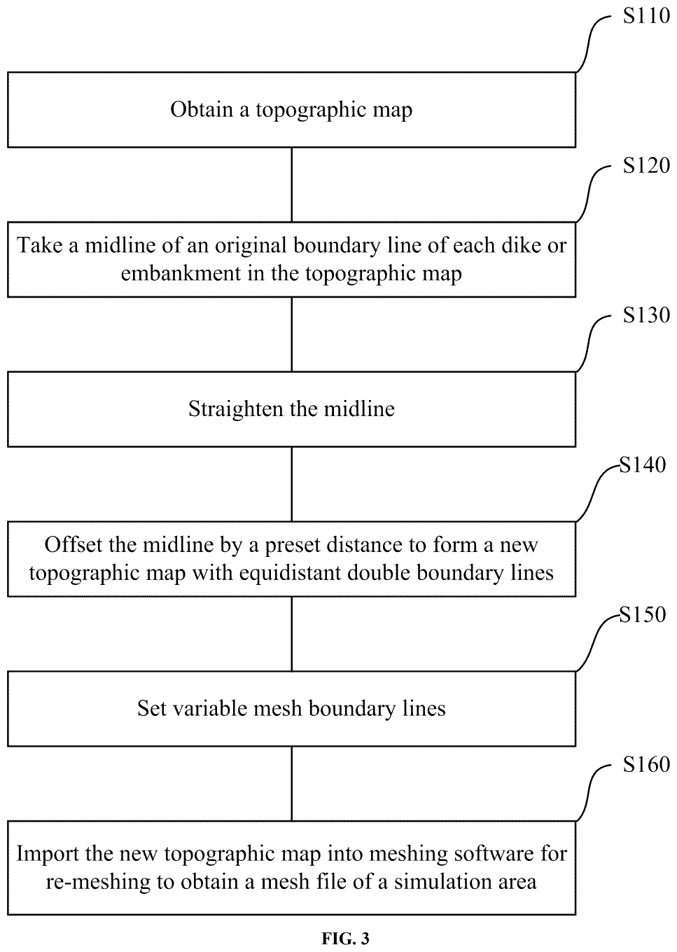

As shown in FIG. 3, a first embodiment of the present disclosure provides a method for optimizing meshing of a shallow lake model, including the following steps:
S110: Obtain a topographic map.
S120: Take a midline of an original boundary line of each dike or embankment in the topographic map.
S140: Offset the midline by a preset distance to form a new topographic map with equidistant double boundary lines.
S160: Import the new topographic map into meshing software for re-meshing to obtain a mesh file of a simulation area.

Compared with the prior art, the method for optimizing meshing of a shallow lake model provided by this embodiment takes the midline of the original boundary line of each dike or embankment, and then offsets the midline by a preset distance to form a new topographic map with equidistant double boundary lines. The new topographic map is imported into meshing software for re-meshing, resulting in a mesh file for the simulation area. This allows for the formation of a layer of uniform triangular cells within the equidistant double boundary lines in the resulting file, where all vertices of the triangular cells are at the same elevation and have a similar shape. This can create a band-like protrusion that fully represents the elevation of the dike or embankment, which is more consistent with the actual situation of the dike or embankment and can achieve the water-blocking effect of the dike or embankment while significantly reducing the computational load of the hydrodynamic model. Additionally, since the water flow movement at the dikes and embankments is very minimal, the optimization through the above method has a small impact on the accuracy of the ultimately established hydrodynamic model.

As shown in FIG. 3, based on the first embodiment, the present disclosure provides another embodiment as follows: The method for optimizing meshing of a shallow lake model includes the following steps:
S110: Obtain a topographic map.
S120: Take a midline of an original boundary line of each dike or embankment in the topographic map.
S130: Straighten the midline: divide a curved portion of the midline into a plurality of segments and replace parts within each segment with a straight line connecting endpoints of the segment, thereby forming a new center.
S140: Offset the midline by a preset distance to form a new topographic map with equidistant double boundary lines.
S150: Set variable mesh boundary lines: offset the equidistant double boundary lines to both sides by a third preset distance d to form preliminary mesh boundary lines, where the third preset distance d is a farthest distance at which the dike or embankment can block the water flow, which can be obtained through measurement or estimation.

At this point, the following three situations may occur:
1. When the preliminary variable mesh boundary lines of a dike or embankment do not intersect with the preliminary mesh boundary lines of a neighboring dike or embankment, i.e., when a distance between the two adjacent dikes or embankments is greater than 2d, the preliminary mesh boundary lines are defined as the variable mesh boundary lines.
2. When the preliminary variable mesh boundary lines of a dike or embankment intersect with the preliminary mesh boundary lines of a neighboring dike or embankment, if a distance between the two adjacent dikes or embankments ranges from d to 2d, a midline of an intersecting part of the preliminary mesh boundary lines is taken, and the midline of the intersecting part is combined with non-intersecting parts to define the variable mesh boundary lines.
3. When the preliminary variable mesh boundary lines of a dike or embankment intersect with the preliminary mesh boundary lines of a neighboring dike or embankment, if a distance between the two adjacent dikes or embankments is less than d, an intersecting part of the preliminary mesh boundary lines is deleted, and non-intersecting parts are combined to define the variable mesh boundary lines.
S160: Import the new topographic map into meshing software for re-meshing to obtain a mesh file of a simulation area.

In S160, the new topographic map obtained is imported into a mesh generator provided by MIKE ZERO for re-meshing to obtain the mesh file of the simulation area, where an area within the equidistant double boundary lines undergoes mesh refinement to form single-layer triangle mesh with a density greater than a density of an area outside the double boundary lines. A part between the equidistant double boundary lines and the variable mesh boundary lines gradually increases in cell size from the equidistant double boundary lines to the variable mesh boundary lines, while the area outside the equidistant double boundary lines uses larger cells to reduce cell density as much as possible.

Due to the blocking effect of the dikes and embankments on the water flow, in S150, the variable mesh boundary lines are set, and cells with gradually increasing sizes are used, which can ensure simulation accuracy while reducing computational load. This approach is particularly suitable for complex terrains like Baiyangdian, where dikes and embankments are scattered.

In some embodiments, in S120, a boundary line of the dike or embankment in the topographic map is offset to one side by a first preset distance to form an offset line, and an elevation of the offset line is consistent with an elevation of the boundary line of the dike or embankment; the dike or embankment is represented by double boundary lines formed by the boundary line and the offset line, where the first preset distance is an average measured width of the dike or embankment. This method is convenient to operate and helps reduce the workload of modifying the topographic map.

In other embodiments, in S120, a boundary line of the dike or embankment in the topographic map is offset to both sides by a second preset distance to form two offset lines, and an elevation of the two offset lines is consistent with an elevation of the original boundary line, and the original boundary line is deleted; the dike or embankment is represented by double boundary lines formed by the two offset lines, where the second preset distance is half of the average measured width of the dike or embankment. This method can more accurately represent specific locations of the dikes and embankments, which is beneficial for improving the accuracy of the hydrodynamic model construction.

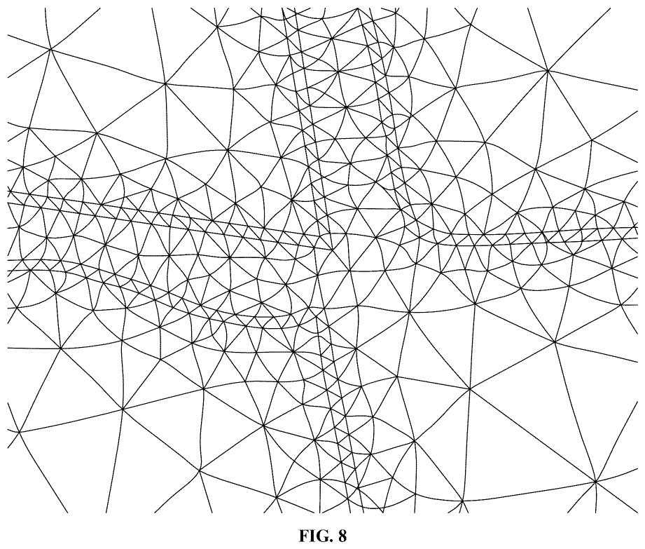

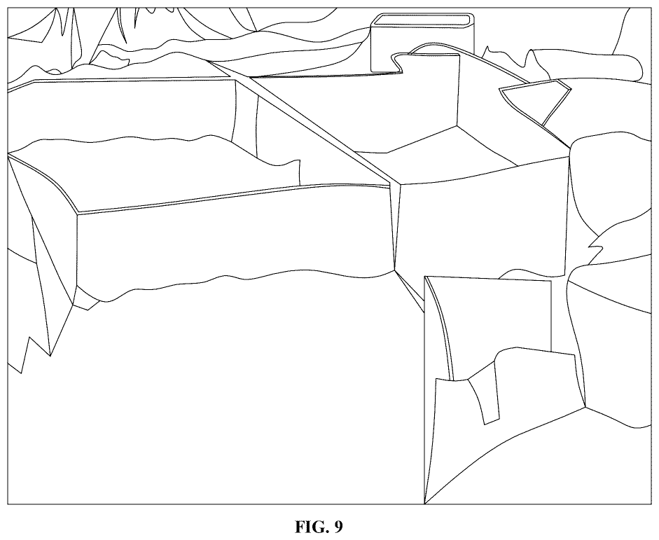

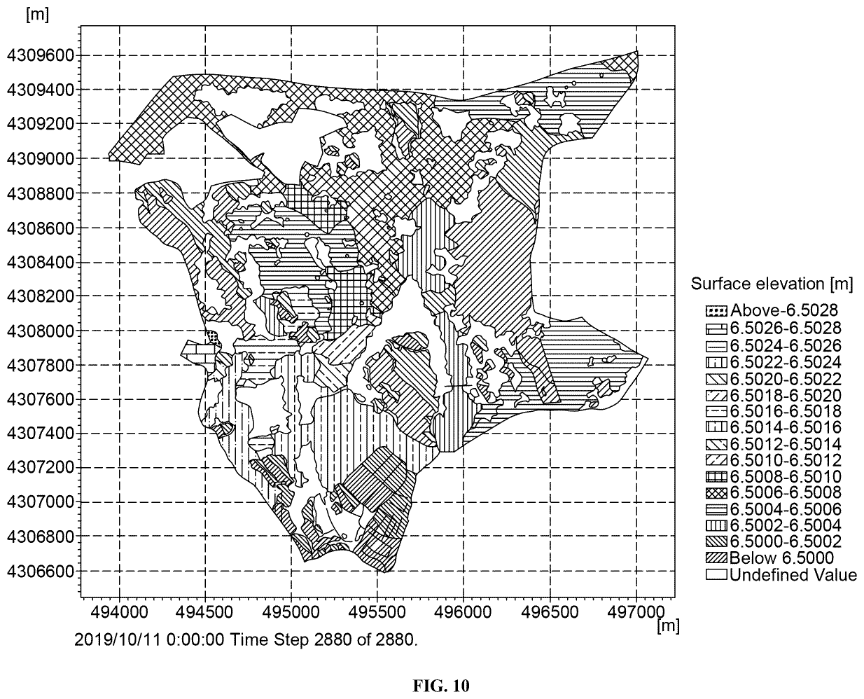

FIG. 8 and FIG. 9 show a mesh file and an elevation map generated using the method for optimizing meshing of a shallow lake model provided by the above embodiment of the present disclosure.

Based on the same inventive concept, a second embodiment of the present disclosure provides a method for establishing a hydrodynamic model, including the following steps:
S100: Obtain a mesh file of a simulation area by using the above method for optimizing meshing of a shallow lake model.
S200: Establish a blank MIKE21 hydrodynamic model in MIKE21 software and importing the mesh file of the simulation area into the MIKE21 software.
S300: Select measurement monitoring points, determine corresponding positions of the measurement monitoring points in the MIKE21 hydrodynamic model as calculation nodes, and collect and output monitoring data from the calculation nodes.
S400: Calibrate parameters of control equations for hydrodynamic indicators based on the monitoring data and prediction data of each calculation node, to simulate and predict the hydrodynamic indicators.
S500: Dynamically update a forecast part of the hydrodynamic model based on the collected monitoring data from each calculation node and simulated values of the hydrodynamic model, to obtain prediction data.
S600: Field verification: select a plurality of measurement points in the hydrodynamic model, obtain flow state data, measure flow states at field locations corresponding to the measurement points, and then compare field measurement data with the flow state data obtained from the hydrodynamic model to verify prediction accuracy of the hydrodynamic model; if a difference between the field measurement data and the flow state data obtained from the hydrodynamic model is within an acceptable range, it proves that the prediction accuracy of the hydrodynamic model is reliable.

Compared with the prior art, the method for establishing a hydrodynamic model provided by the present disclosure uses the method for optimizing meshing of a shallow lake model to mesh the topographic map, allowing the established hydrodynamic model to better reflect the actual situation of the dikes and embankments, achieving the water-blocking effect while significantly reducing the computational load of the hydrodynamic model.

Based on the second embodiment, the present disclosure provides another embodiment as follows:

After importing the mesh file of the simulation area into the MIKE21 software, and before collecting and outputting the monitoring data from the calculation nodes, it is also necessary to integrate multidimensional information of a river channel in a static water state, and map the multidimensional information to initial values of each cell in the MIKE21 hydrodynamic model, where the multidimensional information includes water quality monitoring information, underwater topography information, geographic information, meteorological information, and satellite remote sensing information; the monitoring data from the calculation nodes includes water level data and water flow data; the measurement monitoring points are equipped with water flow monitoring devices and water level monitoring devices.

In S400, the control equations of the hydrodynamic model are as follows:

### Continuity Equation:

$$\frac{\partial h}{\partial t} + \frac{\partial ( hu )}{\partial x} + \frac{\partial ( hv )}{\partial y} = 0 ;$$

### X-Direction Momentum Equation:

$$\frac{\partial p}{\partial t} + \frac{\partial }{\partial x} ( \frac{{p}^{2}}{h} ) + \frac{\partial }{\partial y} ( \frac{pq}{h} ) + gh \frac{\partial ζ}{\partial x} + \frac{gp \sqrt{{p}^{2} + {q}^{2}}}{{c}^{2} {h}^{2}} - \frac{1}{{p}_{ω}} [ \frac{\partial }{\partial x} ( {hτ}_{xx} ) + \frac{\partial }{\partial y} ( {hτ}_{xy} ) ] - Ω q - {fVV}_{x} + \frac{h}{{p}_{ω}} \frac{\partial }{\partial x} ( {p}_{a} ) = {S}_{ix} ;$$

### Y-Direction Momentum Equation:

$$\frac{\partial p}{\partial t} + \frac{\partial }{\partial y} ( \frac{{p}^{2}}{h} ) + \frac{\partial }{\partial x} ( \frac{pq}{h} ) + gh \frac{\partial ζ}{\partial y} + \frac{gp \sqrt{{p}^{2} + {q}^{2}}}{{c}^{2} {h}^{2}} - \frac{1}{{p}_{ω}} [ \frac{\partial }{\partial y} ( {hτ}_{yy} ) + \frac{\partial }{\partial x} ( {hτ}_{xy} ) ] - Ω q - {fVV}_{y} + \frac{h}{{p}_{ω}} \frac{\partial }{\partial y} ( {p}_{a} ) = {S}_{iy} ;$$

where h(x, y, t) represents a bottom elevation (=ζ−d, m); d(x, y, t) represents a water depth (m); ζ(x, y, t) represents a water surface elevation (m); p, q(x, y, t) represents a flow density in direction x or y (m³/s/m), which is equal to μh, vh; μ and v represent flow velocities in directions x and y distributed along the water depth (m/s); C(x, y) represents a Chezy coefficient (m^{1/2}/s); g represents a gravitational acceleration (m/s²); f(V) represents a wind friction coefficient; V, Vx, Vy(x, y, t) represent wind speed flows in directions x and y (m/s); Ω(x, y) represents a Coriolis force parameter, latitude-related (s⁻¹); pa(x, y, t) represents an atmospheric pressure (kg/m/s²); pw represents a water density (kg/m³); x and y represent x-direction and y-direction coordinates; t represents time; τxx, τxy, and τyy represent effective shear stress components.

An implicit alternating direction technique is used to discretize mass and momentum equations of the hydrodynamic model, and resulting matrix equations are solved using the Thomas algorithm; all differential terms and important coefficients are treated using a central difference format, where a truncation error of a Taylor series expansion is required to achieve second to third-order accuracy.

An unstructured mesh is used to mesh the simulation area, employing topographic data for meshing of the simulation area; a terrain is divided into high land areas, village areas, dikes and embankments, areas inside the dikes and embankments, water surface areas, and reed areas based on topographic boundaries; partial mesh refinement is performed for embankment parts, and generalization processing is performed on water surface parts; during meshing of the simulation area using the topographic data, a separate cell size is set for each terrain area, where the water surface area has a largest cell size, and the reed area has a smallest cell size; after completing the meshing of the simulation area, the method further includes deleting and merging small cells to form an unstructured triangle mesh for the simulation area.

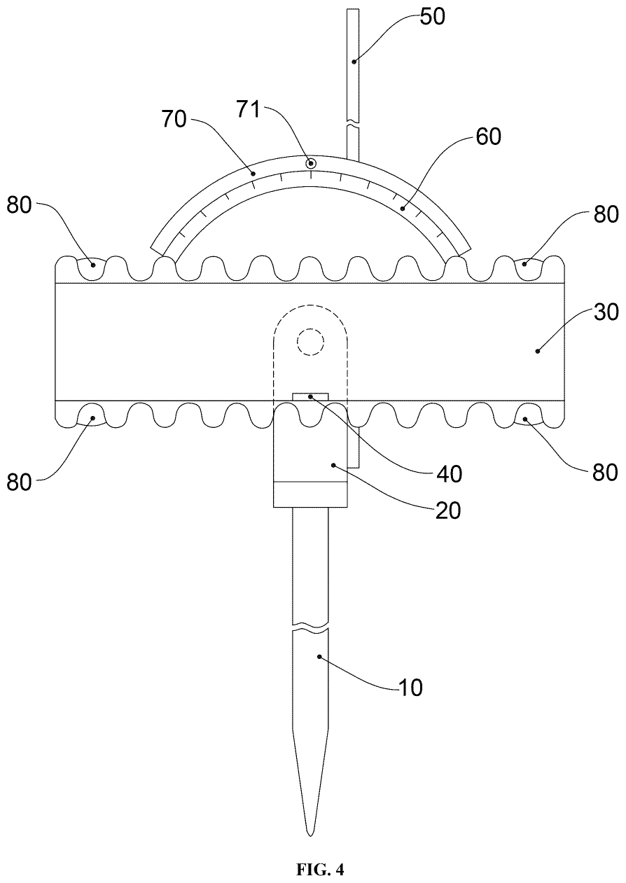

As shown in FIG. 4, in S600, a flow state measurement apparatus is used for measuring the flow states at the field locations. The flow state measurement apparatus includes a fixed pin 10, a rotating connection seat 20, a water flow pipe 30, a flow velocity sensor 40, a depth scale 50, an elevation angle scale 60, a curved bubble tube 70, and a counterweight component 80. The fixed pin 10 is used to be inserted into sediment at the bottom of water. The rotating connection seat 20 is mounted on the fixed pin 10 and has degrees of freedom to rotate along vertical and horizontal axes. The water flow pipe 30 is rotatably connected to the rotating connection seat 20 along the horizontal axis. The flow velocity sensor 40 is located inside the water flow pipe 30. The depth scale 50 has one end connected to the fixed pin 10 or the rotating connection seat 20, and the other end extending upward. The curved bubble tube 70 is a transparent tubular structure in an arc shape, mounted on the water flow pipe 30, where a center of the curved bubble tube 70 is located on the horizontal axis, and a measuring liquid having bubbles is provided inside the curved bubble tube 70. The elevation angle scale 60 is marked with scale lines and is positioned at a side of the curved bubble tube 70 facing the water flow pipe 30, allowing the scale lines to be visible from above. The counterweight component 80 is located on the water flow pipe 30 to adjust the balance of the water flow pipe 30.

During use, the counterweight component 80 keeps the water flow pipe 30 balanced in a horizontal state. The fixed pin 10 is then vertically inserted into the sediment at a measurement point, and the depth scale 50 ensures that the water flow pipe 30 is at a target depth, allowing the water flow at the measurement point to pass through the water flow pipe 30. Once the water flow pipe 30 stabilizes under the hydraulic action of the flow, a flow velocity is read using the flow velocity sensor 40 inside the water flow pipe 30. The position of the bubbles in the curved bubble tube 70 is observed from above, and an elevation angle of the water flow pipe 30 is read based on the corresponding relationship between the position of the bubbles and the scale on the elevation angle scale 60. By aligning the direction of the curved bubble tube 70 or the elevation angle scale 60 with a compass, a horizontal angle of the water flow pipe 30 is read, thus determining the flow state data such as the flow direction and flow velocity at the measurement point. Specifically, the elevation angle and horizontal angle can be read manually or using an underwater camera.

To enhance the smoothness of rotation, the rotating connection seat 20 is connected to the fixed pin 10 and the water flow pipe 30 using low-resistance bearings, waterproof bearings, or magnetic levitation mechanisms.

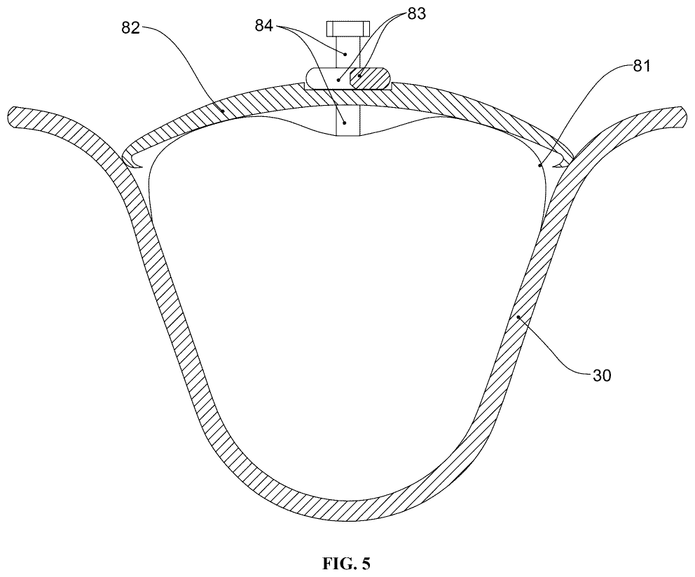

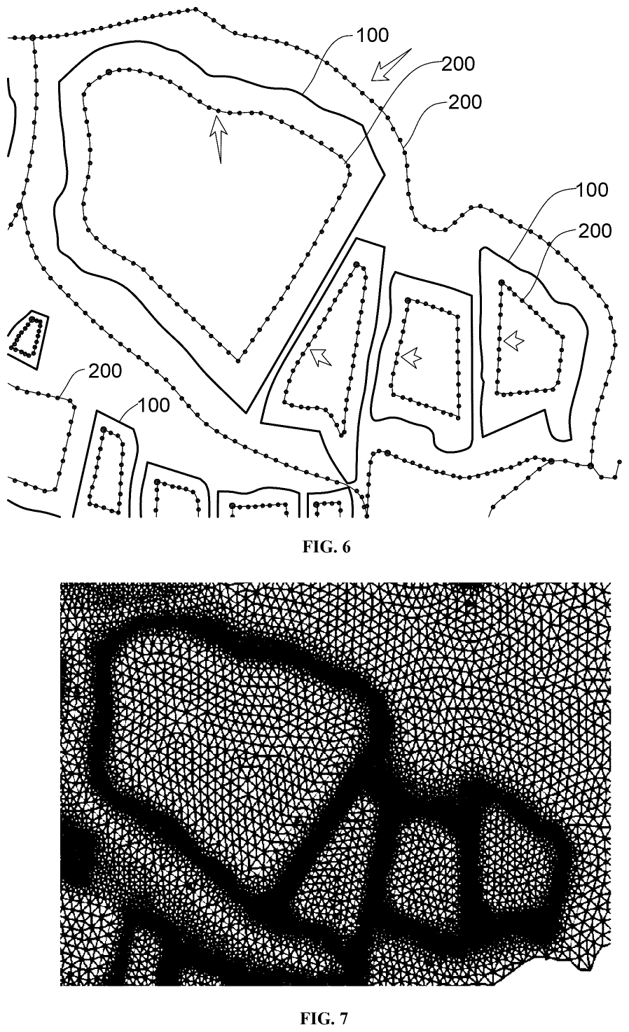

Additionally, the counterweight component 80 can be used to adjust the density of the water flow pipe 30, such that the density of the water flow pipe 30 approximates that of the water at the measurement point, allowing for more precise measurement of the elevation angle. Specifically, as shown in FIG. 5, the water flow pipe 30 uses a double-walled corrugated pipe, with a straight pipe inside to avoid affecting the flow velocity detection, while the outer part is a corrugated pipe that forms a cavity in the pipe wall of the water flow pipe 30 to enhance buoyancy. The counterweight component 80 includes a sac body 81, an outer sealing plate 82, a spring clamp 83, and an inner cavity adjustment bolt 84. The outer sealing plate 82 is secured in the trough of the outer wall of the water flow pipe 30, and the spring clamp 83 is a ring-shaped spring mechanism that presses the outer sealing plate 82 tightly against the trough, forming an annular inner cavity between the outer sealing plate 82 and the outer wall of the water flow pipe 30. The sac body 81 is elongated and placed in the inner cavity, and the outer sealing plate 82 has a threaded hole. The inner cavity adjustment bolt 84 penetrates the outer sealing plate 82 through the threaded hole. The sac body 81 is filled with counterweights.

The material of the counterweights is selected based on the overall density of the water flow pipe 30, flow velocity sensor 40, elevation angle scale 60, and curved bubble tube 70, and can include hydrogen, alcohol, oil, saline solution, sand powder, iron powder, etc. By selecting appropriate types and quantities of counterweights, the overall density of the water flow pipe 30, flow velocity sensor 40, elevation angle scale 60, and curved bubble tube 70 can be adjusted to approximate the density of water. The inner cavity adjustment bolt 84 is then twisted to change the depth of the inner cavity adjustment bolt 84 entering the inner cavity, adjusting the volume of the sac body 81 and the inner cavity, thereby causing a slight change in the overall density for more precise density adjustment.

Before use, it is necessary to calibrate the error of the flow state measurement apparatus, which involves measuring differences between measured parameters and true parameters under laboratory conditions, and establishing a relationship table between different laboratory-measured water flow direction and flow velocity conditions and corresponding differences, allowing for reasonable correction of errors that occur during field measurements. During field measurements, the closest water flow direction and flow velocity are found in the table, and the corresponding error value is read and added to the measured data to correct the error.

In some specific embodiments, the hydrodynamic model is established in a Nanliuzhuang simulation area, which extends north to the Xin'an North Dike, west to the edges of villages such as Yangdiko Village, Beiliuzhuang Village, and Nanliuzhuang Village, east to the Yuanyang Island Scenic Area, and south to the Simen Dike, covering an area of approximately 5.74 square kilometers. The specific method is as follows:
Step 1: In a topographic map, take midlines of boundary lines of dikes and embankments, straighten each midline, and offset each midline by 2 meters to one side to form equidistant double boundary lines, and then set variable mesh boundary lines.
Step 2: Import the modified topographic map into meshing software for meshing, ensuring that cells between two lines simulating the dike or embankment are at the same elevation.
Step 3: Set boundary conditions and various model parameters, such as roughness and wind speed.
Step 4: Construct the hydrodynamic model and analyze simulation results.

Through the establishment of the model, the water-blocking effect of the dikes and embankments is achieved, and the results are satisfactory, as shown in FIG. 8.

What is described above is merely exemplary embodiments of the present disclosure, but not intended to limit the present disclosure. Any modifications, equivalent substitutions, improvements and the like made without departing from the spirit and principles of the present disclosure fall within the protection scope of the present disclosure.

What is claimed is:

1. A method for optimizing meshing of a shallow lake model, comprising the following steps:
S110: obtaining a topographic map;
S120: taking a midline of an original boundary line of each dike or embankment in the topographic map;
S140: offsetting the midline by a preset distance to form a new topographic map with equidistant double boundary lines; and
S160: importing the new topographic map into meshing software for re-meshing to obtain a mesh file of a simulation area.

2. The method for optimizing meshing of a shallow lake model according to claim 1, wherein
in S140, the original boundary line of the dike or embankment in the topographic map is offset to one side by a first preset distance to form an offset line, and an elevation of the offset line is consistent with an elevation of the boundary line of the dike or embankment; the dike or embankment is represented by equidistant double boundary lines formed by the boundary line and the offset line, wherein the first preset distance is an average width of the original boundary line of the dike or embankment.

3. The method for optimizing meshing of a shallow lake model according to claim 1, wherein
in S140, the original boundary line of the dike or embankment in the topographic map is offset to both sides by a second preset distance to form two offset lines, and an elevation of the two offset lines is consistent with an elevation of the original boundary line, and the original boundary line is deleted; the dike or embankment is represented by equidistant double boundary lines formed by the two offset lines, wherein the second preset distance is half of an average width of the original boundary line of the dike or embankment.

4. The method for optimizing meshing of a shallow lake model according to claim 1, wherein
in S160, the new topographic map obtained is imported into a mesh generator provided by MIKE ZERO for re-meshing to obtain the mesh file of the simulation area, wherein an area within the equidistant double boundary lines undergoes mesh refinement to form single-layer triangle mesh with a density greater than a density of an area outside the double boundary lines.

5. The method for optimizing meshing of a shallow lake model according to claim 4, wherein between S120 and S140, the method further comprises:
S130: straightening the midline: dividing a curved portion of the midline into a plurality of segments and replacing parts within each segment with a straight line connecting endpoints of the segment, thereby forming a new center;
between S140 and S160, the method further comprises:
S150: setting variable mesh boundary lines: offsetting the equidistant double boundary lines to both sides by a third preset distance d to form preliminary mesh boundary lines; when the preliminary variable mesh boundary lines of a dike or embankment do not intersect with the preliminary mesh boundary lines of a neighboring dike or embankment, that is, when a distance between the two adjacent dikes or embankments is greater than 2d, defining the preliminary mesh boundary lines as the variable mesh boundary lines; when the preliminary variable mesh boundary lines of the dike or embankment intersect with the preliminary mesh boundary lines of the neighboring dike or embankment, if a distance between the two adjacent dikes or embankments ranges from d to 2d, taking a midline of an intersecting part of the preliminary mesh boundary lines, and combining the midline of the intersecting part with non-intersecting parts to define the variable mesh boundary lines; if the distance between the two adjacent dikes or embankments is less than d, deleting the intersecting part of the preliminary mesh boundary lines, and combining the non-intersecting parts to define the variable mesh boundary lines; and
in S160, a part between the equidistant double boundary lines and the variable mesh boundary lines gradually increases in cell size from the equidistant double boundary lines to the variable mesh boundary lines.

6. A method for establishing a hydrodynamic model, comprising the following steps:
S100: obtaining a mesh file of a simulation area by using the method for optimizing meshing of a shallow lake model according to claim 1;
S200: establishing a blank MIKE21 hydrodynamic model in MIKE21 software and importing the mesh file of the simulation area into the MIKE21 software;
S300: selecting measurement monitoring points, determining corresponding positions of the measurement monitoring points in the MIKE21 hydrodynamic model as calculation nodes, and collecting and outputting monitoring data from the calculation nodes;
S400: calibrating parameters of control equations for hydrodynamic indicators based on the monitoring data and prediction data of each calculation node, to simulate and predict the hydrodynamic indicators; and
S500: dynamically updating a forecast part of the hydrodynamic model based on the collected monitoring data from each calculation node and simulated values of the hydrodynamic model, to obtain prediction data.

7. The method for establishing a hydrodynamic model according to claim 6, wherein in S400, the control equations of the hydrodynamic model are as follows:
continuity equation:
$$\frac{\partial h}{\partial t} + \frac{\partial ( hu )}{\partial x} + \frac{\partial ( hv )}{\partial y} = 0 ;$$
X-direction momentum equation:
$$\frac{\partial p}{\partial t} + \frac{\partial }{\partial x} ( \frac{{p}^{2}}{h} ) + \frac{\partial }{\partial y} ( \frac{pq}{h} ) + gh \frac{\partial ζ}{\partial x} + \frac{gp \sqrt{{p}^{2} + {q}^{2}}}{{c}^{2} {h}^{2}} - \frac{1}{{p}_{ω}} [ \frac{\partial }{\partial x} ( {hτ}_{xx} ) + \frac{\partial }{\partial y} ( {hτ}_{xy} ) ] - Ω q - {fVV}_{x} + \frac{h}{{p}_{ω}} \frac{\partial }{\partial x} ( {p}_{a} ) = {S}_{ix} ;$$
Y-direction momentum equation:
$$\frac{\partial p}{\partial t} + \frac{\partial }{\partial y} ( \frac{{p}^{2}}{h} ) + \frac{\partial }{\partial x} ( \frac{pq}{h} ) + gh \frac{\partial ζ}{\partial y} + \frac{gp \sqrt{{p}^{2} + {q}^{2}}}{{c}^{2} {h}^{2}} - \frac{1}{{p}_{ω}} [ \frac{\partial }{\partial y} ( {hτ}_{yy} ) + \frac{\partial }{\partial x} ( {hτ}_{xy} ) ] - Ω q - {fVV}_{y} + \frac{h}{{p}_{ω}} \frac{\partial }{\partial y} ( {p}_{a} ) = {S}_{iy} ;$$
wherein h(x, y, t) represents a bottom elevation (=ζ−d, m); d(x, y, t) represents a water depth (m); ζ(x, y, t) represents a water surface elevation (m); p, q(x, y, t) represents a flow density in direction x or y (m³/s/m), which is equal to μh, vh; μ and v represent flow velocities in directions x and y distributed along the water depth (m/s); C(x, y) represents a Chezy coefficient (m^{1/2}/s); g represents a gravitational acceleration (m/s²); f(V) represents a wind friction coefficient; V, Vx, Vy(x, y, t) represent wind speed flows in directions x and y (m/s); Ω(x, y) represents a Coriolis force parameter, latitude-related (s⁻¹); pa(x, y, t) represents an atmospheric pressure (kg/m/s²); pw represents a water density (kg/m); x and y represent x-direction and y-direction coordinates; t represents time; τxx, τxy, and τyy represent effective shear stress components; and
an implicit alternating direction technique is used to discretize mass and momentum equations of the hydrodynamic model, and resulting matrix equations are solved using the Thomas algorithm; all differential terms and important coefficients are treated using a central difference format, wherein a truncation error of a Taylor series expansion is required to achieve second to third-order accuracy.

8. The method for establishing a hydrodynamic model according to claim 6, wherein
after importing the mesh file of the simulation area into the MIKE21 software, and before collecting and outputting the monitoring data from the calculation nodes, multidimensional information of a river channel in a static water state is integrated and mapped to initial values of each cell in the MIKE21 hydrodynamic model;
the multidimensional information comprises water quality monitoring information, underwater topography information, geographic information, meteorological information, and satellite remote sensing information; the monitoring data from the calculation nodes comprises water level data and water flow data;
the measurement monitoring points are equipped with water flow monitoring devices and water level monitoring devices;
an unstructured mesh is used to mesh the simulation area, employing topographic data for meshing of the simulation area; a terrain is divided into high land areas, village areas, dikes and embankments, areas inside the dikes and embankments, water surface areas, and reed areas based on topographic boundaries;
partial mesh refinement is performed for embankment parts, and generalization processing is performed on water surface parts;
during meshing of the simulation area using the topographic data, a separate cell size is set for each terrain area, wherein the water surface area has a largest cell size, and the reed area has a smallest cell size; after completing the meshing of the simulation area, the method further comprises deleting and merging small cells to form an unstructured triangle mesh for the simulation area.

9. The method for establishing a hydrodynamic model according to claim 6, further comprising:
S600: field verification: selecting a plurality of measurement points in the hydrodynamic model, obtaining flow state data, measuring flow states at field locations corresponding to the measurement points, and then comparing field measurement data with the flow state data obtained from the hydrodynamic model to verify prediction accuracy of the hydrodynamic model.

10. The method for establishing a hydrodynamic model according to claim 9, wherein
in S600, a flow state measurement apparatus is used for measuring the flow states at the field locations; the flow state measurement apparatus comprises a fixed pin (10), a rotating connection seat (20), a water flow pipe (30), a flow velocity sensor (40), a depth scale (50), an elevation angle scale (60), a curved bubble tube (70), and a counterweight component (80); the fixed pin (10) is used to be inserted into sediment at the bottom of water; the rotating connection seat (20) is mounted on the fixed pin (10) and has degrees of freedom to rotate along vertical and horizontal axes; the water flow pipe (30) is rotatably connected to the rotating connection seat (20) along the horizontal axis; the flow velocity sensor (40) is located inside the water flow pipe (30); the depth scale (50) has one end connected to the fixed pin (10) or the rotating connection seat (20), and the other end extending upward; the curved bubble tube (70) is a transparent tubular structure in an arc shape, mounted on the water flow pipe (30), wherein a center of the curved bubble tube (70) is located on the horizontal axis, and a measuring liquid having bubbles is provided inside the curved bubble tube (70); the elevation angle scale (60) is marked with scale lines and is positioned at a side of the curved bubble tube (70) facing the water flow pipe (30), allowing the scale lines to be visible from above; the counterweight component (80) is located on the water flow pipe (30) to adjust the balance of the water flow pipe (30).

11. The method for establishing a hydrodynamic model according to claim 6, wherein
in S140, the original boundary line of the dike or embankment in the topographic map is offset to one side by a first preset distance to form an offset line, and an elevation of the offset line is consistent with an elevation of the boundary line of the dike or embankment; the dike or embankment is represented by equidistant double boundary lines formed by the boundary line and the offset line, wherein the first preset distance is an average width of the original boundary line of the dike or embankment.

12. The method for establishing a hydrodynamic model according to claim 6, wherein
in S140, the original boundary line of the dike or embankment in the topographic map is offset to both sides by a second preset distance to form two offset lines, and an elevation of the two offset lines is consistent with an elevation of the original boundary line, and the original boundary line is deleted; the dike or embankment is represented by equidistant double boundary lines formed by the two offset lines, wherein the second preset distance is half of an average width of the original boundary line of the dike or embankment.

13. The method for establishing a hydrodynamic model according to claim 6, wherein
in S160, the new topographic map obtained is imported into a mesh generator provided by MIKE ZERO for re-meshing to obtain the mesh file of the simulation area, wherein an area within the equidistant double boundary lines undergoes mesh refinement to form single-layer triangle mesh with a density greater than a density of an area outside the double boundary lines.

14. The method for establishing a hydrodynamic model according to claim 13, wherein between S120 and S140, the method further comprises:
S130: straightening the midline: dividing a curved portion of the midline into a plurality of segments and replacing parts within each segment with a straight line connecting endpoints of the segment, thereby forming a new center;
between S140 and S160, the method further comprises:
S150: setting variable mesh boundary lines: offsetting the equidistant double boundary lines to both sides by a third preset distance d to form preliminary mesh boundary lines; when the preliminary variable mesh boundary lines of a dike or embankment do not intersect with the preliminary mesh boundary lines of a neighboring dike or embankment, that is, when a distance between the two adjacent dikes or embankments is greater than 2d, defining the preliminary mesh boundary lines as the variable mesh boundary lines; when the preliminary variable mesh boundary lines of the dike or embankment intersect with the preliminary mesh boundary lines of the neighboring dike or embankment, if a distance between the two adjacent dikes or embankments ranges from d to 2d, taking a midline of an intersecting part of the preliminary mesh boundary lines, and combining the midline of the intersecting part with non-intersecting parts to define the variable mesh boundary lines; if the distance between the two adjacent dikes or embankments is less than d, deleting the intersecting part of the preliminary mesh boundary lines, and combining the non-intersecting parts to define the variable mesh boundary lines; and
in S160, a part between the equidistant double boundary lines and the variable mesh boundary lines gradually increases in cell size from the equidistant double boundary lines to the variable mesh boundary lines.
